(19) United States
(12) Patent Application Publication
(10) Pub. No.: US 2007/0019273 A1
(43) Pub. Date: Jan. 25, 2007

(54) Instant shade

(76) Inventors: James Freeman, Arlington, TX (US); Doris Freeman, Arlington, TX (US)

Correspondence Address: JAMES RAY & ASSOCIATES, 2640 PITCAIRN ROAD, MONROEVILLE, PA, 15146, US

(21) Appl. No.: 11/488,583

(22) Filed: Jul. 18, 2006

Related U.S. Application Data
(60) Provisional application No. 60/700,409, filed on Jul. 19, 2005.

(51) Int. Cl. G02F 1/03

(52) U.S. Cl. 359/241

(57) ABSTRACT

An improved partially photochromic window glass for a vehicle. The partially photochromic window glass comprises at least one of a windshield, a side window and a rear window and a transition lens material having at least one predetermined darkening strength depending on where the transition lens material is to be used disposed therein beginning at an upper edge thereof and extending downwardly therefrom for at least between about 75.0 percent to about 90.0 percent of the distance.

### CROSS REFERENCE TO RELATED APPLICATIONS

This application is closely related to and claims benefit from U.S. Provisional Application Ser. No. 60/700,409 filed Jul. 20, 2005.

### FIELD OF THE INVENTION

The present invention relates, in general, to a transition window, and, more particularly, the present invention relates to a transition window in which the window will darken so as to reduce glare but transition to being perfectly clear in a dark environment so as to not impair vision through such windows

### BACKGROUND OF THE INVENTION

Automobile windshields have had a variety of modifications through the years in an attempt to make driving safer under adverse conditions. One of these adverse conditions is bright sunlight. Virtually everyone who has ever driven has encountered the case where the suns rays are so bright that the driver cannot see. Most times this occurs in early morning or late at night when the sun's rays are at such an angle that they hit the windshield such that the driver is blinded.

Standard tinted windows have been used and have been modified to the point that these types of windows can significantly block glare and UV rays providing safety from potentially damaging effects.

However, this tint is not recommended for overcast days or evening hours since it tends to darken what little light that is available. During these times, tinted glass can actually make objects difficult if not impossible to see.

Homes and commercial buildings also are affected by bright sunlight. This is particularly true where there are windows in the building which face east or west. In these cases they are subject to bright morning sunlight or the glare from the afternoon sun which can be very annoying and even detrimental to furniture, particularly upholstered furniture, which can cause fading of the colors in the fabric if exposed to sunlight for prolonged periods of time.

Thus, it would be advantageous if the windows, automobile windows in particular, were made of a material which would darken in bright sunlight but lighten to a clear glass in a dark environment.

### SUMMARY OF THE INVENTION

In a first aspect the present invention provides an improved partially photochromic window glass for a vehicle. The partially photochromic window glass comprises at least one of a windshield, a side window and a rear window and a transition lens material having at least one predetermined darkening strength depending on where the transition lens material is to be used disposed therein beginning at an upper edge thereof and extending downwardly therefrom for at least between about 75.0 percent to about 90.0 percent of the distance.

In another aspect of the invention there is provided an improved photochromic window glass for at least one of a home and a commercial building. The partially photochromic glass comprising a first window facing east and exposed to morning sunlight, a second window facing west and exposed to afternoon sunlight and a third window facing a direction which is rarely exposed to direct morning and afternoon sunlight, each of the first and the second and the third windows having a different transition lens material. Such first window having a first predetermined darkening strength, such second window having a second predetermined darkening strength and such third window having a third predetermined darkening strength.

In yet another aspect of the invention there is provided an improved photochromic window glass for at least one of a home and a commercial building, such photochromic glass comprising a sky light. Such sky light has a transition lens material disposed therein and has a predetermined darkening strength.

### OBJECTS OF THE INVENTION

It is, therefore, one of the primary objects of the present invention to provide a transition lens material for car windshields that will darken in bright sunlight but clear up in dim light or darkness.

Another object of the present invention is to provide a transition lens material for windows in a home or a commercial building.

Still another object of the present invention is to provide a transition lens material that has a darkening strength depending upon where it is to be used.

Yet another object of the present invention is to provide a transition lens material for windows in a home or a commercial building in which windows facing east and west will have greater darkening power than windows that do not get either morning or afternoon sun.

It is another object of the present invention to provide transition lens for windows in sun roofs.

It is still another object of the present invention to provide transition lens for windows in sky lights whether they are domed or flat.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a perspective view of the an automobile having transition lens material in all of the windows.

FIG. 2 is a perspective view of a building having transition lens material disposed on all the windows showing the windows on a sunny day.

FIG. 3 is a perspective view of the top a building showing a sky light.

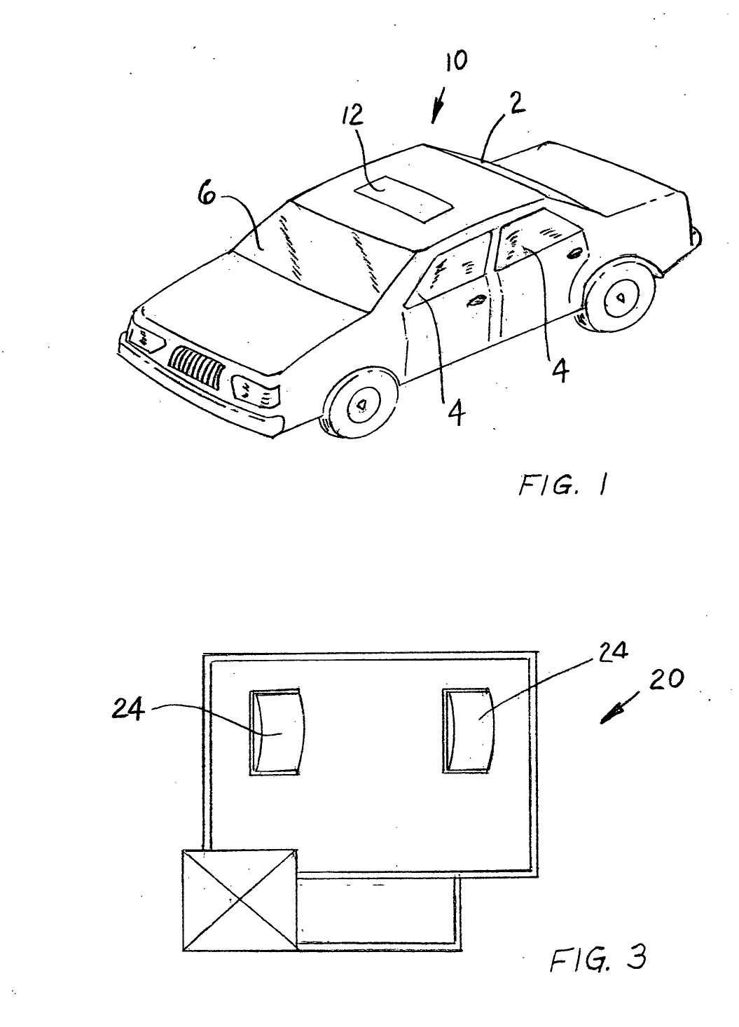

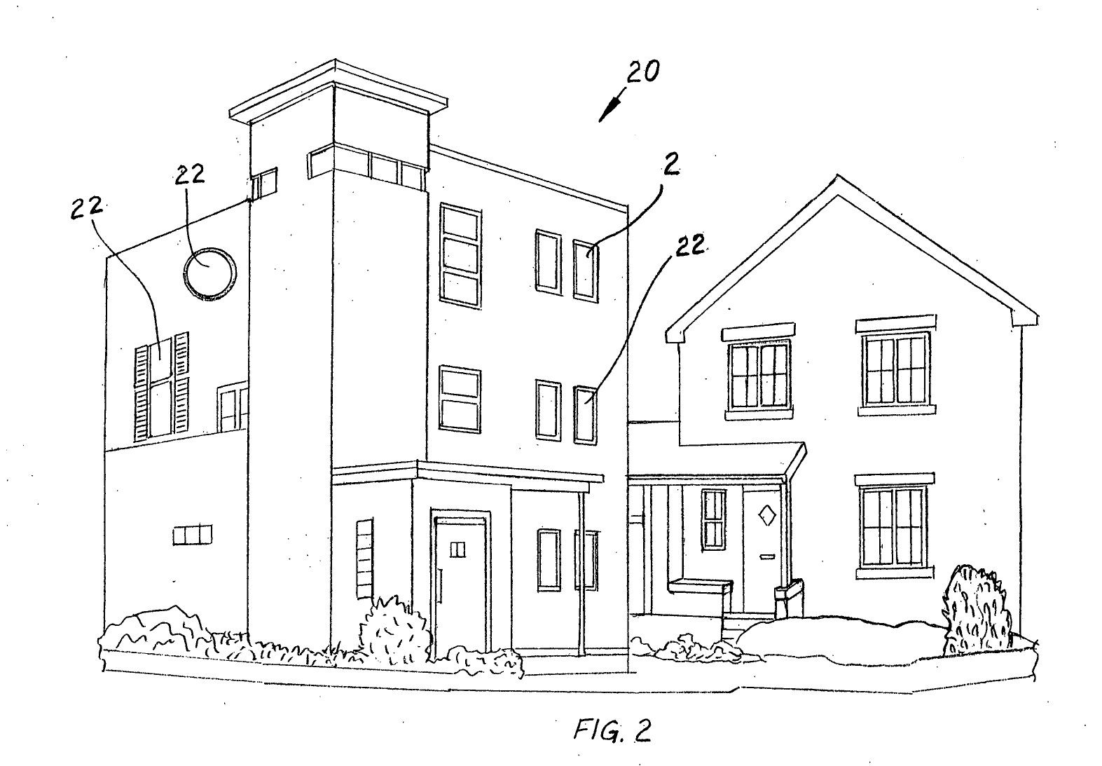

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

Transition lens materials have been used in sun glasses and in windows. Typically, a transition glass contains millions of photochromic molecules which absorb UV light. Thus, when exposed to sunlight a chemical reaction occurs wherein the photochromic molecules are transformed into colored light absorbers. Exposure to sunlight activates the photochromic molecules which darkens the transition glass and absorbs most of the UV rays. Conversely, during periods of darkness or the absence of sunlight the photochromic molecules are essentially deactivated and the glass reverts to the clear state and what light is available can pass through unimpeded.

In a first aspect the present invention provides an improved partially photochromic window glass for a vehicle, generally designated 10. The partially photochromic window glass comprises at least one of a windshield 2, a side window 4 and a rear window 6 and a transition lens material having at least one predetermined darkening strength, depending on where the transition lens material is to be used, disposed therein beginning at an upper edge thereof and extending downwardly therefrom for at least between about 75.0 percent to about 90.0 percent of the distance.

It is preferred that the darkening strength of the transition lens material for the rear window 6 is greater than for the side windows 4 and the windshield 2 and also it is preferred that the predetermined darkening strength for the side windows 4 is greater than for the windshield 2. This is because although it is important for the darkening of the windshield 2 be great enough to eliminate the bright sunlight from impairing the vision of the driver but it is also important to not have the transition material in the windshield 2 be so great that it can prevent the driver from seeing clearly through the windshield on a bright day. Whereas, it is less important to have the rear window 6 be as clear as the windshield 2.

It is also preferred that such transition lens material extends downwardly to about 80 percent of the distance from a top of the windshield 2 to a bottom of such windshield 2.

The transition lens material extends downwardly to about 90 percent of the distance from a top of the rear window 6 to a bottom of the rear window. Not having the transition lens material cover the entire window is more of a cost saving since such transition lens material is quite costly and any savings is important.

In the discussion where vehicles are mentioned it is important to realize that such vehicles 10 includes not only automobiles but trucks, including the large semis, as well. Also included in the term vehicles are such transit vehicles such as buses or rail cars.

It should be noted that the invention further provides that such glass used for a sun roof 12 in a vehicle having such sun roof 12 has such transition lens material disposed therein. It is also preferred that the darkening strength of said transition material for such sun roof 12 is greater than that for the rear window 6 and that the transition material extends throughout the sun roof 12.

In another aspect of the invention there is provided a an improved photochromic window glass 22 for at least one of a home and a commercial building, generally designated 20. The partially photochromic glass comprising a first window facing east and exposed to morning sunlight, a second window facing west and exposed to afternoon sunlight and a third window facing a direction which is rarely exposed to direct morning and afternoon sunlight, each of the first and the second and the third windows having a different transition lens material. Such first window having a first predetermined darkening strength, such second window having a second predetermined darkening strength and such third window having a third predetermined darkening strength.

In either the home or commercial building 20 it is important that the darkening strength of the second window material which faces west is greater than such first darkening strength or such third darkening strength since the afternoon sun can be the hottest and it is desirable to block as much of the hot rays as possible. Whereas, it is important that the first predetermined darkening strength of such first window that faces east is greater than the third darkening strength for windows that face neither east nor west and so never get the direct sunlight.

Such windows 22 for the home or commercial building 22 be they the first window, second window or third window each have a predetermined shape. Such predetermined shape can be one of rectangular, oval, and circular. The most prevalent shape for the windows would obviously be rectangular.

In yet another aspect of the invention for either a home or commercial building 20 which have a sky light 24 there is provided an improved photochromic window glass having a transition lens material disposed therein and having a predetermined darkening strength.

Such sky light 24, whether in a home or commercial building, can be either flat, semisperical (domed)or arcuate. Whether such sky light is flat, semispherical (domed) or arcuate it is important that such transition lens material extend throughout the sky light 24 so as to keep the bright light subdued and yet letting in as much light as possible when it begins to darken outside.

Thus, the present invention provides better visibility by transitioning windows from natural clear to a safe tint. This provides safety at times when bright sunlight would normally prohibit easily viewing surroundings without the problems associated with standard tinted windows. The windows transition from their original clear glass to tinted glass when exposed to bright sunlight. When bright sunlight hits the window the window gradually tints, visible only from the outside, to reduce the glare inside. When the brightness of the sun fades so does the tint of the window. When the surroundings are relatively dark the window will appear clear so as to let as much light pass through as possible.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

We claim:

1. An improved partially photochromic window glass for a vehicle, said partially photochromic window glass comprising:
(a) at least one of a windshield, a side window and a rear window; and
(b) a transition lens material having at least one predetermined darkening strength depending on where said transition lens material is to be used disposed therein beginning at an upper edge thereof and extending downwardly therefrom for at least between about 75.0 percent to about 90.0 percent of the distance.

2. The improved partially photochromic window glass, according to claim 1, wherein a darkening strength of said transition lens material for said rear window is greater than for said side windows and said windshield.

3. The improved partially photochromic window glass, according to claim 2, wherein said predetermined darkening strength for said side windows is greater than for said windshield.

4. The improved partially photochromic window glass, according to claim 2, wherein said transition lens material extends downwardly to about 80 percent of the distance from a top of said windshield to a bottom of said windshield.

5. The improved partially photochromic window glass, according to claim 1, wherein said vehicle includes automobiles, trucks and transit vehicles.

6. The improved partially photochromic window glass, according to claim 1, wherein said transition lens material extends downwardly to about 90 percent of the distance from a top of said rear window to a bottom of said rear window.

7. The improved partially photochromic window glass, according to claim 1, wherein said vehicle further includes a sun roof with said transition lens material disposed therein.

8. The improved partially photochromic window glass, according to claim 7, wherein said sun roof has a darkening strength of said transition material is greater than that for said rear window.

9. The improved partially photochromic window glass, according to claim 1, wherein said transition lens material extends throughout said sun roof.

10. An improved photochromic window glass for at least one of a home and a commercial building, said partially photochromic glass comprising a first window facing east and exposed to morning sunlight, a second window facing west and exposed to afternoon sunlight and a third window facing a direction which is rarely exposed to direct morning and afternoon sunlight, each of said first and said second and said third windows having a different transition lens material, said first window having a first predetermined darkening strength, said second window having a second predetermined darkening strength and said third window having a third predetermined darkening strength.

11. The improved photochromic window glass for at least one of a home and a commercial building, according to claim 10, wherein said second predetermined darkening strength of said second window facing west is greater that said first and said third predetermined darkening strength.

12. The improved photochromic window glass for at least one of a home and a commercial building, according to claim 10, wherein said first predetermined darkening strength of said first window facing east is greater than said third darkening strength.

13. The improved photochromic window glass for at least one of a home and a commercial building, according to claim 10, wherein said first window, said second window and said third window each have a predetermined shape.

14. The improved photochromic window glass for at least one of a home and a commercial building, according to claim 13, wherein said predetermined shape is one of rectangular, oval, and circular.

15. The improved photochromic window glass for at least one of a home and a commercial building, according to claim 14, wherein said predetermined shape is rectangular.

16. An improved photochromic window glass for at least one of a home and a commercial building, said partially photochromic glass comprising a sky light, said sky light having a transition lens material disposed therein and having a predetermined darkening strength.

17. The improved photochromic window glass for at least one of a home and a commercial building, according to claim 16, wherein said sky light is one of flat, semispherical and arcuate.

18. The improved photochromic window glass for at least one of a home and a commercial building, according to claim 17, wherein said sky light is arcuate.

19. The improved photochromic window glass for at least one of a home and a commercial building, according to claim 16, wherein said transition lens material extends throughout said sky light.
